(19) United States
(12) Patent Application Publication
(10) Pub. No.: US 2015/0229264 A1
(43) Pub. Date: Aug. 13, 2015

(54) CELESTIAL BODY DIGITAL TRACKING SYSTEM

(71) Applicant: The University of Scranton, Scranton, PA (US)

(72) Inventors: Nicholas P. Truncale, Scranton, PA (US); Nathan Williams, Carbondale, PA (US)

(73) Assignee: The University of Scranton, Scranton, PA (US)

(21) Appl. No.: 14/620,637

(22) Filed: Feb. 12, 2015

Related U.S. Application Data
(60) Provisional application No. 61/938,869, filed on Feb. 12, 2014.

(51) Int. Cl. H02S 20/32; G05B 15/02

(52) U.S. Cl. CPC H02S 20/32; G05B 15/02

(57) ABSTRACT

A control system and method for controlling a tracking device based on the position of a celestial object, such as the sun, the moon, or any heavenly body. The control system includes a tracking device configured to follow movement of the celestial object based on astronomical data for the celestial object, motor for moving the tracking device, and a computer for controlling the motor. The computer is configured to obtain the astronomical data; calculate an amount of movement for the tracking device; and reposition the tracking device in order to track the movement of the celestial object. The tracking device may include solar applications, cameras, antennae, satellite dishes, or any device envisioned to track celestial objects.

### RELATED APPLICATION

This application claims the benefit of priority to U.S. Provisional Patent Application Ser. No. 61/938,869, filed on Feb. 12, 2014, the contents of which are incorporated in this application by reference.

### TECHNICAL FIELD

The present invention relates generally to controlling a moveable device in order to track a celestial object, and, more particularly, to controlling a moveable device, such as a solar panel or array, in order to track the position of the sun, for example, and optimize the output (e.g., power) of the device.

### BACKGROUND OF THE INVENTION

Mechanical tracking systems are available to reposition a variety of devices including radio telescopes, antennae, and even television satellite dishes. These systems are large and often unaffordable for the small project developer. In the case of photovoltaic (PV) or solar modules, these systems are typically installed as arrays of modules with a fixed orientation depending on the site characteristics and cost constraints. One orientation that is used on flat roofs is the so-called horizontal configuration in which the modules face straight up towards the sky. Another fixed configuration, that is considered the best overall fixed configuration for PV installations in North America, is one in which the modules face south and are tilted with respect to the ground at an angle equal to the site latitude. For example, for Scranton, Pa., with a latitude of approximately 41 degrees north of the equator, the modules may be tilted at about a 40-45 degree angle with respect to the ground. The angle between the sun's position and the surface of the earth is called the solar altitude angle. Some installations may use a module tilt angle equal to 90% of the latitude, in order to give a higher PV energy output in the summer, when there is more solar energy available. This configuration would give less solar energy in the winter, however, so it may or may not be superior depending on the seasonal energy needs of the user.

Two-axis solar tracking by continually orienting the solar modules perpendicular to the rays of the sun throughout each day of the year would produce the maximum energy. This is because the response of a solar module to a ray of light is proportional to the cosine of the angle between a line perpendicular to the module surface and the solar ray impinging on the surface. If the solar radiation is perpendicular to the surface, the maximum power for a given solar flux will be obtained (cosine 0°=1). Thus, there exists a need for an inexpensive control system which is able to control one or more solar panels in order to obtain the optimal energy production. There also exists a similar need for other devices, such as radio telescopes, antennae, and satellite dishes, to have an inexpensive and effective tracking control system to optimize performance.

### SUMMARY OF THE INVENTION

To meet this and other needs, and in view of its purposes, the present invention provides for control systems and methods for tracking a celestial object, such as the sun, the moon, or any heavenly body. By tracking the celestial object throughout a given time period, a tracking device can perform optimally and efficiently for its intended function. In the case of a solar panel, for instance, the movement of the sun may be tracked for a single day, and the solar panel can produce optimal power outputs over the course of the day. In the case of other devices, such as cameras, antennae, or satellite dishes, the device may track any heavenly object with a known trajectory or data regarding its position (e.g., satellites) in order to enhance and improve the device's efficiency and output (e.g., video or radio transmission or reception).

In one embodiment, the present invention provides a control system for tracking a celestial object, such as the sun. The tracking device is configured to follow movement of the celestial object based on astronomical data for the celestial object. The control system includes a computer including a programmable microprocessor. The computer performs certain functions including, for example: obtaining astronomical data for the celestial object at a given tabular interval based on a location of the tracking device and a date (e.g., the global position of the tracking device and the calendar month); calculating an amount of movement for the tracking device based on the astronomical data including a motor time duration for each tabular interval; repositioning the tracking device by moving the tracking device for the amount of movement calculated to track the celestial object based on the astronomical data for the celestial object; and repeatedly repositioning the tracking device throughout each tabular interval to track the celestial object.

A motor is controlled by the computer for moving the tracking device. The motor may include a bi-directional DC motor, for example. The motor controls the amount and duration of movement of the tracking device. For example, the amount of movement may be a constant movement of the motor for the motor time duration calculated at each tabular interval. An H-bridge motor driver circuit may connect the computer to the motor to apply a load to the motor, for example. The H-bridge motor driver circuit may reverse the polarity of the motor to drive the motor and move the tracking device in the intended manner.

The control system may also include other function components. For example, the control system may include an analog-to-digital converter to collect data from the tracking device. In the instance when the tracking device includes at least one solar panel (e.g., a solar panel array), the data collected may include solar panel output voltage data including voltage and current data. This and any other data obtained may be writable to a data file, such as a text file.

The control system may further include a wireless connection configured to allow a user to interface with the computer, upload the astronomical data for the celestial object, retrieve data obtained from the tracking device, or complete a combination of these functions or other similar functions.

The control system may include a real time clock to determine a time including the real and present time. Time may include a calendar year, month, day, hour, minute, second, or even fraction of a second. In the case of a solar device, the time may include a present month, day, and year. The calendar may be any suitable calendar known in the art and suitable for the function of the tracking device (e.g., Gregorian calendar, ordinal date, solar calendar, lunar calendar, astronomical calendar, etc.).

The control system may also include a home position sensor, for example, to verify if the tracking device is or is not in a starting position. The home position sensor may include an emitting diode detector to determine if the tracking device is positioned in the initial start position. In the case when the tracking device includes at least one solar panel, the initial start position may be an East-facing position or the most Eastward position for the tracking device (e.g., for North American applications).

The control system may also include a power supply. In particular, the computer, microprocessor, any of the other components which make up the control system, or any auxiliary or separate components may include a power supply including, for example, a power bank and a power adapter. The control system and any components contained in or separate from the control system may also include a back-up power source such as a battery or other auxiliary power. The control system may also include other functional components or peripheral components known in the art, e.g., smart phones, tablets, laptops, keyboards, monitors, etc.

The celestial object may include the sun, the moon, a planet, a star, or any heavenly body. The celestial object may also include man-made objects, such as satellites. The applications may vary depending on the type of celestial object to be followed. For example, the tracking device may include one or more solar panels (e.g., a solar array), telescopes (e.g., including the optical and radio variety), antennae, satellite dishes, cameras (e.g., closed circuit cameras), and similar types of movable devices (or devices which are presently stationary but would have enhanced performance if rendered moveable). The celestial object to be followed or tracked will depend on the intended function of the device, for example: solar panels would follow the sun; telescopes may follow the moon, planets, stars, or the like; satellite dishes may follow a communications satellite; and so on.

According to another embodiment, the present invention provides a method for tracking the celestial object. In particular, the method may include importing astronomical data to the computer for the celestial object at the given tabular interval based on a location and a date. The amount of movement for the tracking device may be calculated by the computer based on the astronomical data including the motor time duration for each tabular interval. The tracking device may be repositioned by the motor by moving the tracking device the amount of movement previously calculated to track the celestial object based on the astronomical data for the celestial object. The repositioning step may be repeated throughout each tabular interval such that the tracking device follows the celestial object for a given duration (e.g., for a day from sunrise to sunset, in the case of a solar panel).

Before the tracking device begins movement for a given interval (e.g., for a given day), the tracking device may be started at a home position. In the case of a solar panel, the home position may be the most Easterly direction for the start of a day with sunrise in the East.

The tabular interval may be determined to be any suitable interval necessary for the tracking device to follow the celestial object. For example, the tabular interval may range from 1-120 minutes or more depending on the frequency or significance of movement of the celestial object. In the case of a solar device, the tabular interval may be about thirty (30) minutes, for example.

The date or dates for importing the astronomical data may also be determined at an appropriate time or interval. In the case of solar tracking, for example, the data may be found daily, weekly, monthly, or quarterly. For solar tracking, it may be preferred to obtain the data monthly due to the different trajectories of the sun in the different months and seasons of the year. Of course, this interval may depend upon the location of the tracking device and the typical trajectory of the celestial object. A more frequent data collection would allow for more accurate data, but a monthly frequency provides for good tracking for a solar panel without requiring large amounts of data storage. In the case of a monthly frequency, the data could be obtained at the beginning of the month, end of the month, or the middle of the month. In order to obtain an average trajectory for a solar application, a mid-month data collection may be used (e.g., January 15 data are used for dates ranging from January 1^{st} to January 31^{st}). Thus, for a 12-month year, twelve astronomical data tables would be used.

The location for astronomical data collection or retrieval may be based on any suitable location, such as the state, city, county, municipality, or the like, in which the tracking device is positioned or located. For accuracy, it may be preferred to use the location of the tracking device defined by longitude and latitude. The precision in defining the location may be determined based on the application and function of the tracking device.

The method may include also collecting and storing the astronomical data, for example, in a text file. In the case when the tracking device is a solar panel, the method may include collecting voltage data, current data, or both types of data from the tracking device for power and energy calculations. The method may include wirelessly communicating with a user to allow the user to interface with the computer, uploading the astronomical data for the celestial object, retrieving data obtained from the tracking device, or a combination of these steps, or other similar steps. In addition, the astronomical data may be imported wirelessly and automatically. Alternatively, the astronomical data may be uploaded manually. The astronomical data may be obtained, for example, from the U. S. Naval Observatory. In the case of a solar application, the astronomical data may include the azimuth of the sun in degrees (East of North), the altitude of the sun in degrees, or both values for each interval of time (e.g., at each half hour interval).

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 shows a block circuit diagram according to one embodiment of the present invention;

FIG. 2 also depicts a block circuit diagram according to one embodiment of the present invention;

FIG. 3 depicts a flow chart showing inputs and outputs to obtain astronomical data from the U.S. Naval Observatory, for example;

FIG. 4 shows a flow chart for an algorithm suitable for importing the astronomical data and controlling the motor according to one embodiment of the present invention;

FIGS. 5A and 5B depict an exemplary microcomputer and schematic according to one embodiment for the control system;

FIG. 6 shows another schematic for the control system according to one embodiment of the present invention;

FIG. 7 shows a wiring schematic according to one embodiment of the present invention;

FIGS. 8A-8E provide photographs showing different orientations of the box housing the control system according to one embodiment of the present invention;

FIG. 9 is a photograph of an exemplary solar panel which may be used in conjunction with the control system; and

FIG. 10 provides a plot showing the power and energy outputs for a solar panel using the control system according to one embodiment on a sunny day as compared to a conventional, stationary orientation.

### DETAILED DESCRIPTION OF THE INVENTION

The present invention provides for control systems, methods, and non-transitory computer readable media including software for tracking a celestial object, such as the sun, the moon, or any heavenly body. The movement of the celestial object may be followed or tracked throughout a given time period (e.g., over the course of a day) in order to enhance the performance of the tracking device. In solar applications, for example, the movement of the sun may be tracked for a single day (e.g., from sunrise to sunset) in order to optimize the power outputs of the device. For other applications, such as cameras, antennae, or satellite dishes, the device may track any heavenly object with a known trajectory or data on its global position (e.g., satellites) in order to optimize the device's performance (e.g., video or radio transmission or reception).

According to one embodiment, the present invention provides a control system for tracking the celestial object. The celestial object may include the sun (the star present at the center of our solar system), the moon (which orbits Earth), any planet or moon in our solar system or beyond, any star (e.g., the North Star), constellation, or any heavenly body. The celestial object may also include man-made objects, such as artificial satellites including communications satellites, space shuttles or other flying objects, space stations, and the like.

The applications for tracking the celestial object may vary depending on the type of celestial object to be followed or tracked. For example, the tracking device may include one or more solar panels including any type of photovoltaic or solar arrays, telescopes including optical and radio telescopes, antennae, satellite dishes, cameras including closed circuit cameras, and similar types of movable devices. The devices may include telescopes, antennae, satellite dishes, cameras, and the like which are capable of transmitting and/or receiving information. Moveable devices may also include devices which are presently stationary but performance could be enhanced or optimized by movement. The celestial object to be followed or tracked will depend on the intended function of the device, for example: solar panels may follow the sun (e.g., from sunrise to sunset); telescopes may follow the moon, planets, stars, or the like (e.g., from dusk until dawn); satellite dishes may follow a communications satellite (e.g., over the course of a 24-hour period); and the like depending on the application and the celestial object being followed.

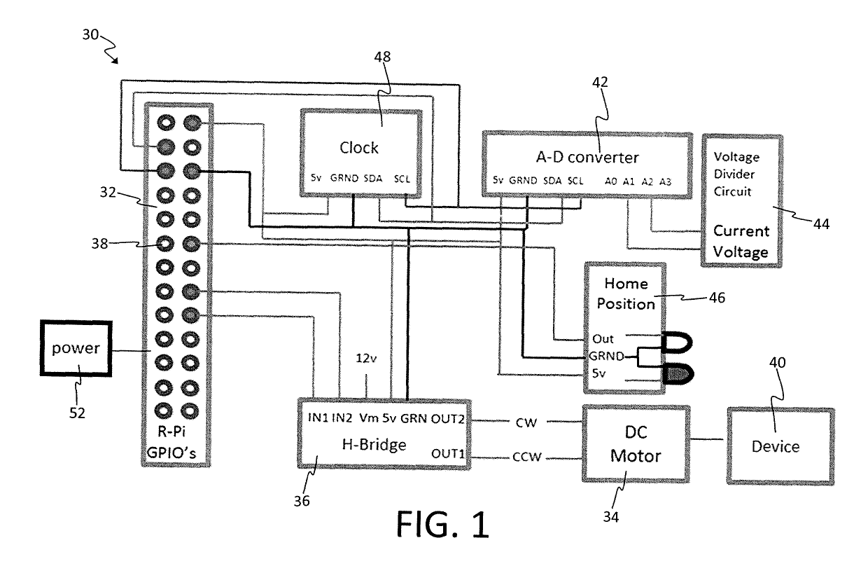

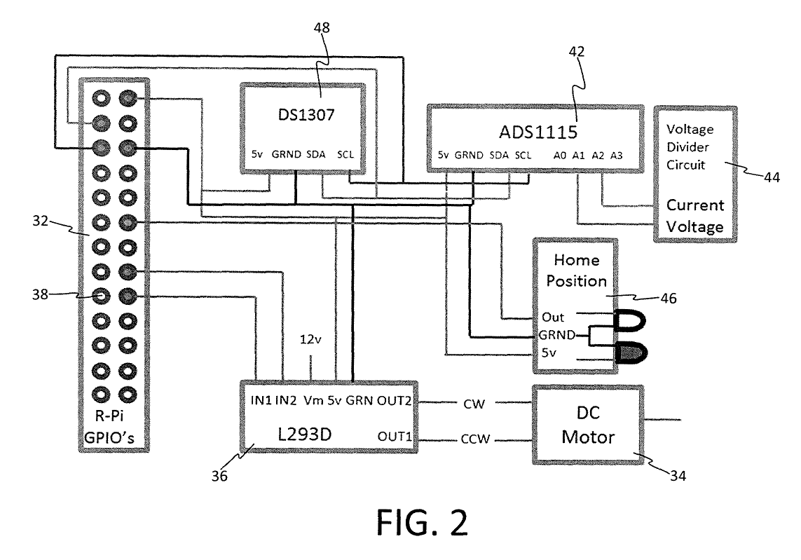

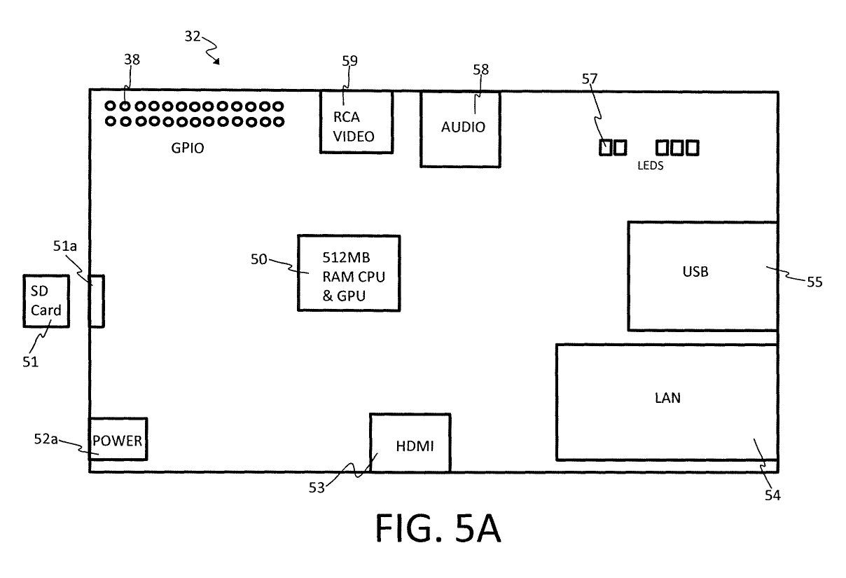

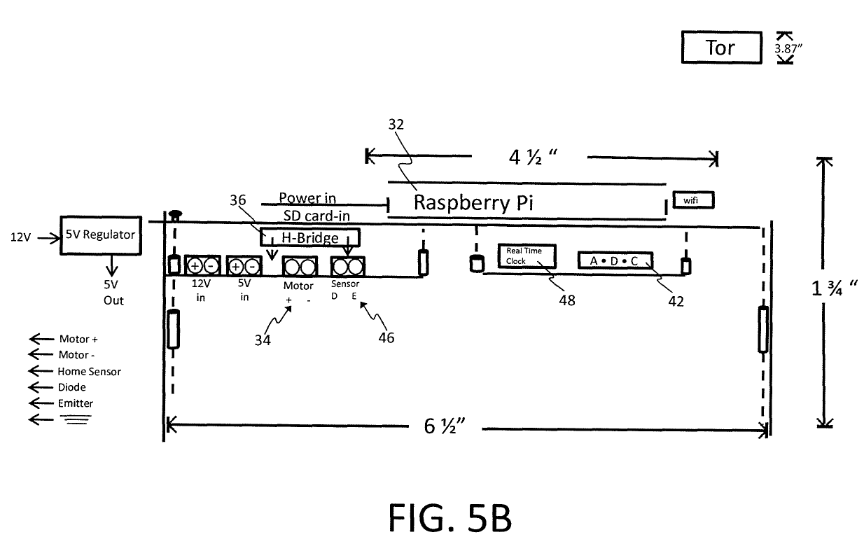

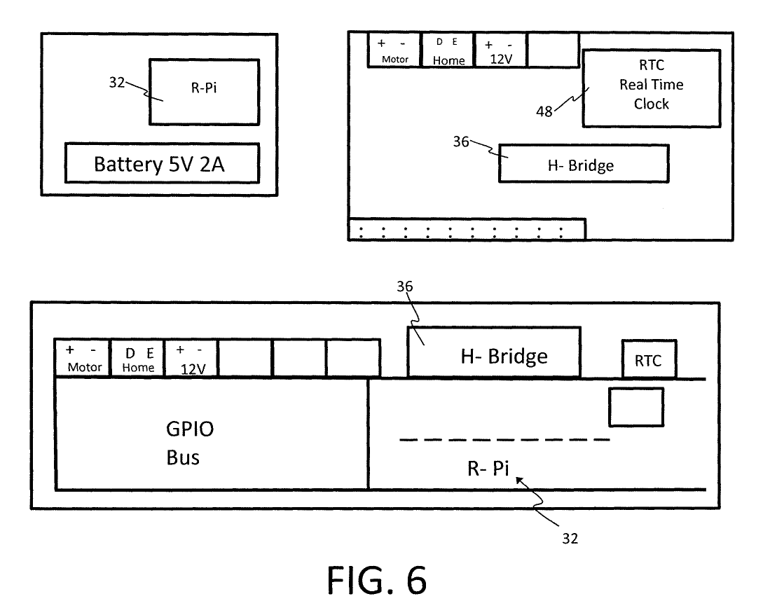

Referring now to the drawing, in which like reference numbers refer to like elements throughout the various figures that comprise the drawing, and for illustration purposes, FIGS. 1 and 2 depict a control system 30 including a computer 32, a motor 34, and a tracking device 40. The computer 32 includes a programmable microprocessor with general purpose input and output pins 38 (GPIOs). The computer 32 may be a compact or small microcomputer 32, such as a RASPBERRY PI® computer 32, which can be obtained from the Raspberry Pi Foundation, a UK registered charity, with a website at http://www.raspberrypi.org/. The RASPBERRY PI® computer 32 is a very small credit-card sized computer 32, which is affordable and low cost. For example, as depicted in FIGS. 5A and 5B, the RASPBERRY PI® computer 32 may include a single board 50 containing a memory card 51 including the slot 51a for the memory card 51 (e.g., a secure digital (SD) card), a power port 52a, an audio/video interface 53 (e.g., a high-definition multimedia interface (HDMI)), a local area network (LAN) 54 or wireless local area network (WLAN), a universal serial bus (USB) port 55, a combination random access memory (RAM), central processing unit (CPU) and graphics processing unit (GPU) 56 (e.g., a 512 MB RAM CPU and GPU), one or more light displays 57 (e.g., light emitting diodes (LEDs)), an audio output 58, and a video output 59 (e.g., an RCA video output).

The computer 32 is preferably a microcomputer or mini PC comprising a processor or microprocessor. Other mini PCs include the Mac Mini, available from Apple Inc. of Cupertino, Calif.; and any of various Mini Android PCs available from different manufacturers. The processor may execute instructions, codes, computer programs, scripts which it accesses from hard disk, floppy disk, optical disk (these various disk-based systems may all be considered secondary storage), read only memory (ROM), RAM, or network connectivity devices. A microcontroller may not provide for the same functionality, however, such as the ability for a user to interface and connect with the control system 30 (e.g., to upload and/or retrieve data).

The present invention can further be embodied in the form of computer-implemented processes and apparatus for practicing such processes, for example, and can be embodied in the form of computer program code embodied in tangible media, such as floppy diskettes, fixed (hard) drives, CD ROM's, magnetic tape, fixed/integrated circuit devices, or any other computer-readable storage medium, such that when the computer program code is loaded into and executed by the computer 32, the computer 32 becomes an apparatus for practicing the invention. The computer 32 may be contained in a suitable case known in the art, which may include a weatherproof or waterproof box.

Regardless of the specific computer 32 used in the control system 30, it is programmed to control the motor 34 in order to move the position of the tracking device 40. The motor 34 may include a bi-directional DC motor, for example. The motor 34 controls the amount and duration of movement of the tracking device 40. For example, the amount of movement may be a constant movement of the motor 34 for the motor time duration as calculated or determined. An H-bridge motor driver circuit 36 may connect the computer 32 to the motor 34 to apply a load to the motor 34, for example, to reverse the polarity of the motor 34 to drive the motor 34 and move the tracking device 40 in the intended manner. The H-bridge motor driver circuit 36 is an electronic circuit that enables a voltage to be applied across a load in either direction. Any suitable H-bridge motor driver circuit 36 known in the art may be selected. The motor 34 is directly controlled by the H-bridge motor driver circuit 36 such that the motor 34 is interfaced with the general purpose input and output pins 38 of the computer 32.

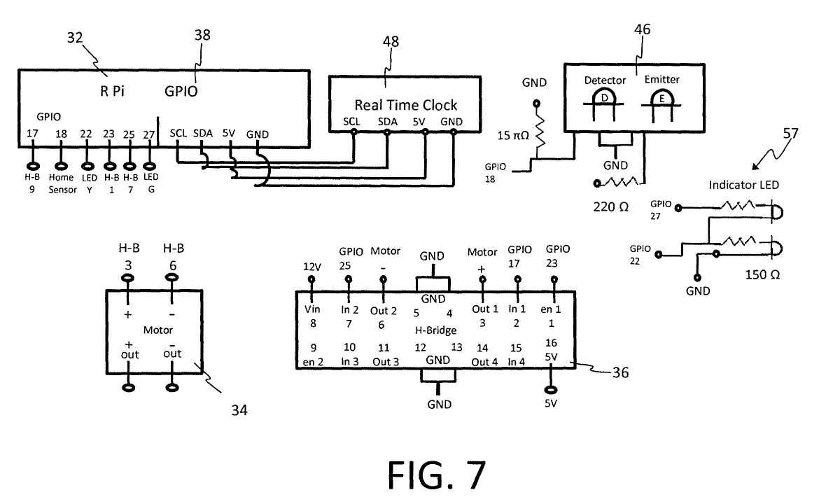

The control system 30 may also include other functional components, such as, but not limited to, analog-to-digital converters 42, real time clocks 48, wireless connections (connected, for example, to the USB 55 or LAN 54), sensors 46, power supplies 52, and other conventional functional components or peripheral components known in the art, e.g., smart phones, tablets, laptops, keyboards, monitors, routers, etc. (not shown). For example, the hardware architecture for the control system 30 may function, for example, with the use of the real time clock 48, the 16-Bit analog to digital converter 42, the H-bridge motor driver circuit 36, the infrared (IR) home-position sensor 46, and a 5200 mAh power bank. In addition, the voltage may be collected across a one ohm (1Ω) power resistor to provide the current. The connections of these components can be viewed in the block diagram provided in FIG. 2. FIG. 7 depicts a potential wiring schematic for each of the components.

The control system 30 may include the analog-to-digital converter 42 to collect data from the tracking device 40. The control system 30 may also include a voltage divider circuit 44 which determines the current and voltage. In the instance when the tracking device 40 includes at least one solar panel (e.g., a solar panel array), the analog-to-digital converter 42 and the voltage divider circuit 44 allow for collection of the solar panel output voltage data throughout the day or over a given period of time. In particular, the data collected may include solar panel output voltage data including voltage and current data. The method may include collecting voltage data, current data, or both types of data from the tracking device 40 for power and energy calculations. These and any other data obtained may be written to a data file, such as a text file. Due to the functionality of the computer 32, a user is able to directly or remotely interface and connect with the control system 30 in order to upload and retrieve the data, such as the solar panel output voltage data.

The control system 30 may include the real time clock 48 to determine a time including the real and present time. The real time clock 48 is used to ensure the program executes periodically at the proper time in case of power failure, for example. Time may include a calendar year, month, day, hour, minute, second, or even a fraction of a second. In the case of the solar device, the time may include a present month, day, and year. The calendar may be any suitable calendar known in the art and suitable for the function of the tracking device 40 (e.g., Gregorian calendar, ordinal date, solar calendar, lunar calendar, astronomical calendar, etc.).

The control system 30 may further include a wireless connection or network connectivity. The wireless connection may include a wireless local area network (WLAN), Wi-Fi, bluetooth, or similar wireless technology. The network connectivity may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices may enable the processor to communicate with the Internet or one or more intranets. With such a network connection, it is contemplated that the processor might receive information from the network, or might output information to the network in the course of performing its intended functions. The wireless connection or network connectivity may be configured to allow a user to remotely interface and connect with the control system 30. In particular, the wireless access may allow a user to interface with the computer readable medium, upload the astronomical data for the celestial object, retrieve data obtained from the tracking device 40, or perform a combination of these or other similar functions.

The control system 30 may also include one or more sensors 46. The sensor 46 may be a home position sensor 46, for example, to verify if the position of the tracking device 40 is or is not in a starting position. In addition to the H-bridge motor driver circuit 36 for motor control, the infrared home-position sensor 46 may be used to ensure the motor 34 is returned to the proper location at the end of every cycle. The home position sensor 46 may include an emitting diode detector to determine if the tracking device 40 is positioned in the initial start position. In the case when the tracking device 40 includes at least one solar panel, the initial start position may be an East-facing position or the most Eastward position for the tracking device 40.

The control system 30 may also include the power supply 52. For example, the power supply 52 may connect to the power port 52a on the computer 32. To minimize the chance of failure, the control system 30 may be powered by a power bank, which is simultaneously charged by a 5V 1A power adapter. In particular, the computer 32 including the microprocessor or any of the other components which make up the control system 30, or any auxiliary or separate components may include any suitable power supply 52 including a power bank, a power adapter, and the like. The control system 30 and any components contained in or separate from the control system 30 may also include a back-up power source, such as a battery or other auxiliary power (not shown).

The control system 30 may also include other conventional functional components or peripheral components known in the art, e.g., smart phones, tablets, laptops, mice, keyboards, monitors, printers, image scanners, microphones, liquid crystal displays (LCDs), touch screen displays, keypads, switches, dials, track balls, voice recognizers, card readers, paper tape readers, etc. In particular, a smart phone or tablet may be used to access the software, upload the astronomical data, and retrieve data obtained from the tracking device 40. The peripheral components may be coupled directly or indirectly to the system via input/output connectors 38, audio/video interface 53, USB port 55, the audio output 58, or the video output 59 of the computer 32 with connecting cables or may be accessed wirelessly through suitable connections. Any of the components described for the control system 30 may be integrated together or separated apart as would be recognized by one of ordinary skill in the art.

According to another embodiment, the present invention provides a method for tracking the celestial object. In particular, the method may include importing astronomical data to the programmable microprocessor for the celestial object at a given tabular interval based on a location and a date. The amount of movement for the tracking device 40 may be calculated based on the astronomical data including the motor time duration for each tabular interval. The tracking device 40 may be repositioned by moving the tracking device 40 the amount of movement previously calculated to track the celestial object based on the astronomical data for the celestial object. The repositioning step may be repeated throughout each tabular interval such that the tracking device 40 follows the celestial object for a given duration (e.g., for a day from sunrise to sunset, in the case of a solar panel).

Before the tracking device 40 begins movement for a given interval (e.g., for a given day), the tracking device 40 may be started at a home position. In the case of a solar panel, the home position may be the most Easterly direction or the Eastern-most position of the tracking device 40.

The tracking device 40 is configured to follow movement of the celestial object based on astronomical data for the celestial object. The astronomical data may be collected, for example, by observing and recording information on the movement of the celestial object from a given location (e.g., the location of the tracking device 40). If available, the astronomical data may be obtained from any reliable source. In the case of sun, moon, and other celestial object astronomical data, for example, reliable data may be obtained from the U. S. Naval Observatory with offices in Washington, D.C. The U.S. Naval Observatory's official website is http://aa.usno.navy.mil. Appropriate data may include, for example, the azimuth of the sun in degrees (East of North); the altitude of the sun in degrees; the azimuth of the moon in degrees (East of North); the altitude of the moon in degrees; the fraction of the moon illuminated; tables of sunrise and sunset information; tables of moonrise and moonset information; the rise, transit, and set of any of the following celestial objects, for example: Sun, Moon, Mercury, Venus, Mars, Jupiter, Saturn, Uranus, Neptune, Pluto, Achernar, Adhara, Aldebaran, Altair, Antares, Arcturus, Betelgeuse, Canopus, Capella, Deneb, Fomalhaut, Hadar, Mimosa, Polaris, Pollux, Procyon, Regulus, Rigel, Rigil Kent., Sirius, Spica, and Vega; or any other suitable data on the celestial object.

The date or dates for importing the astronomical data may be determined at an appropriate time or interval. In the case of solar tracking, for example, the data may be found daily, weekly, monthly, or quarterly. For solar tracking, it may be preferred to obtain the data monthly due to the different trajectories of the sun in the different months and seasons of the year. Of course, this interval may depend upon the location of the tracking device and the typical trajectory of the celestial object. A more frequent data collection would allow for more accurate data, but a monthly frequency provides for good tracking for a solar panel without requiring large amounts of data storage. In the case of a monthly frequency, the data could be obtained at the beginning of the month, end of the month, or the middle of the month. In order to obtain an average trajectory for a solar application, a mid-month data collection may be used (e.g., January 15 data are used for dates ranging from January 1^{st} to January 31^{st}). Accordingly, the astronomical data may be comprised of twelve data sets or files representing each of the twelve months of the year.

The location for astronomical data collection or retrieval may be based on any suitable location, such as the state, city, county, municipality, or the like, in which the tracking device is positioned or located. For accuracy, it may be preferred to use the location of the tracking device defined by longitude and latitude. The precision in defining the location may be determined based on the application and function of the tracking device.

The tabular interval may be determined to be any suitable interval necessary for the tracking device 40 to follow the celestial object. For example, the tabular interval may range from 1-120 minutes, 1-100 minutes, 1-50 minutes, 20-40 minutes, 25-35 minutes, or any suitable tabular interval for the given application. In the case of a solar device, the tabular interval may be about thirty (30) minutes, for example.

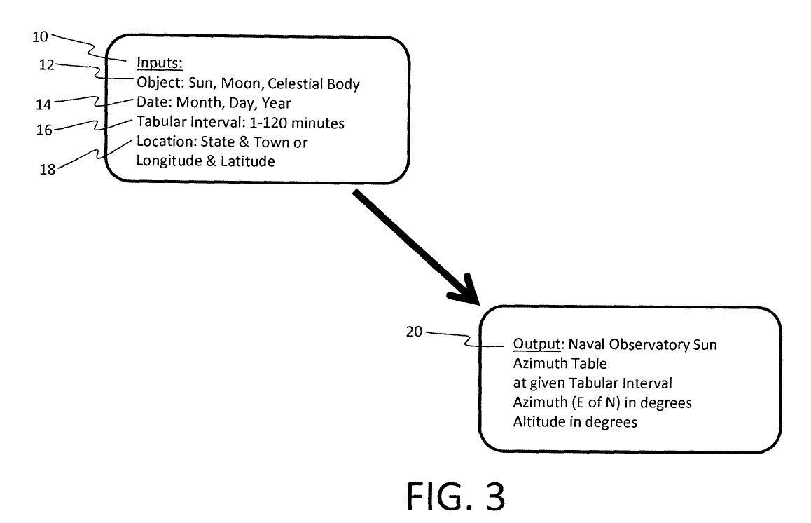

FIG. 3 depicts a number of inputs 10, which may be used to generate the output 20, the astronomical data. In particular, the inputs 10 may include the object 12 to be tracked (e.g., the sun, the moon, or the celestial body); the date 14 (e.g., the month, day, and year); the tabular interval 16 (e.g., a value ranging from 1-120 minutes); and the location 18 (e.g., the state and town; longitude and latitude; a time zone) of the tracking device 40. These inputs 10 are used to obtain one or more tables of data, the output 20, including the astronomical data for the given inputs 10, which provide the position of the celestial object at the given tabular interval 16. Other inputs 10 or outputs 20 useful or necessary to develop the astronomical data of interest may be used as would be known to one of ordinary skill in the art.

In the case of a solar application, the astronomical data may include the azimuth of the sun in degrees (East of North), the altitude of the sun in degrees, or both values for a given interval of time. By way of example, a sample sun azimuth table is provided in Table 1 showing the altitude and azimuth of the sun at a half hour tabular interval of time ranging from 6:30 until 18:00 military time.

TABLE 1
Sample Azimuth Table

Astronomical Applications Dept.
U.S. Naval Observatory
Washington, DC 20392-5420
LOCATION: SCRANTON, PENNSYLVANIA
°, °,
LATITUDE AND LONGITUDE: W 75 40, N41 25
Altitude and Azimuth of the Sun
DATE: Jan. 29, 2014
TIME ZONE: Eastern Standard Time

| | | Azimuth |
|---|---|---|
| | Altitude | (East of North) |
| hour:minute | Degrees (°) | Degrees (°) |
| 06:30 | −9.1 | 105.8 |
| 07:00 | −3.8 | 110.6 |
| 07:30 | 1.7 | 115.5 |
| 08:00 | 6.5 | 120.6 |
| 08:30 | 11.1 | 126.1 |
| 09:00 | 15.5 | 131.9 |
| 09:30 | 19.5 | 138.1 |
| 10:00 | 23.0 | 144.7 |
| 10:30 | 25.9 | 151.9 |
| 11:00 | 28.2 | 159.5 |
| 11:30 | 29.9 | 167.4 |
| 12:00 | 30.7 | 175.6 |
| 12:30 | 30.7 | 183.9 |
| 13:00 | 29.9 | 192.1 |
| 13:30 | 28.4 | 200.1 |
| 14:00 | 26.1 | 207.7 |
| 14:30 | 23.2 | 214.9 |
| 15:00 | 19.7 | 221.6 |
| 15:30 | 15.8 | 227.8 |
| 16:00 | 11.4 | 233.7 |
| 16:30 | 6.8 | 239.1 |
| 17:00 | 2.0 | 244.3 |
| 17:30 | −3.4 | 249.2 |
| 18:00 | −8.8 | 254.0 |

As provided in the example shown in Table 1, the inputs 10 may include the object 12 to be tracked (the sun); the date 14 (Jan. 29, 2014); the tabular interval 16 (30 minute intervals); and the location 18 (Scranton, Pa.) of the tracking device 40. These inputs 10 entered into the U. S. Naval Observatory website provide for one or more tables of data, the output 20, including the astronomical data identified as the altitude and azimuth (East of North) in degrees, which provide the position of the sun at the given tabular interval 16 of thirty (30) minutes for the specific location, Scranton, Pa., in this case. Thus, in the case of a solar application, the astronomical data may include the azimuth of the sun in degrees (East of North), the altitude of the sun in degrees, or both values for each interval of time (e.g., at each half hour interval).

This astronomical data, for example, in the form of text files may be entered into or uploaded into the memory or non-transitory computer readable medium provided in the control system 30. The method may include also collecting and storing the astronomical data, for example, in the text file. The software or executable code exists for causing the computer 32 or programmable microprocessor to perform certain functions. In particular, the software or executable code causes the computer 32 to obtain the astronomical data for the celestial object at the given tabular interval based on the location of the tracking device 40 and the date (e.g., the global position of the tracking device 40 and the calendar month). This step may include automatically obtaining (e.g., remotely and wirelessly uploading) this information at regular intervals (e.g., daily). Alternatively, this step may include manually uploading the data, for example, as obtained from the U.S. Naval Observatory. By way of example, data identified in Table 1 obtained from the U.S. Naval Observatory may be uploaded to the program monthly or twelve months may be uploaded for the year. In addition, the method may include wirelessly communicating with a user to allow the user to interface with the computer readable medium, uploading the astronomical data for the celestial object, retrieving data obtained from the tracking device 40, or completing a combination of these functions or other similar functions.

According to another embodiment, the present invention provides a non-transitory computer readable medium comprising executable code or software for causing the programmable microprocessor to obtain astronomical data for the celestial object at the given tabular interval based on the location of the tracking device 40 and the date; calculate movement for the tracking device 40 based on the astronomical data including the motor time duration for each tabular interval; reposition the tracking device 40 by moving the tracking device 40 to the position calculated to track the celestial object based on the astronomical data for the celestial object; and repeated repositioning of the tracking device 40 throughout each tabular interval to track the celestial object.

The software causes the computer 32 to calculate an amount of movement for the tracking device 40 based on the astronomical data including the motor time duration for each tabular interval 16. Based on this determined amount of movement, the tracking device 40 is repositioned by moving the tracking device 40 for the amount of movement calculated to track the celestial object. The movement may be linear, in the x-direction, y-direction, or both directions, constant, intermittent, etc. Preferably, the movement is linear in the x-direction for a constant rate of movement. The tracking device 40 is repeatedly repositioned throughout each tabular interval 16 to track the celestial object. In the case of a solar panel, for example, set on a 30 minute interval, the solar panel may be re-oriented at the beginning of each 30 minute cycle.

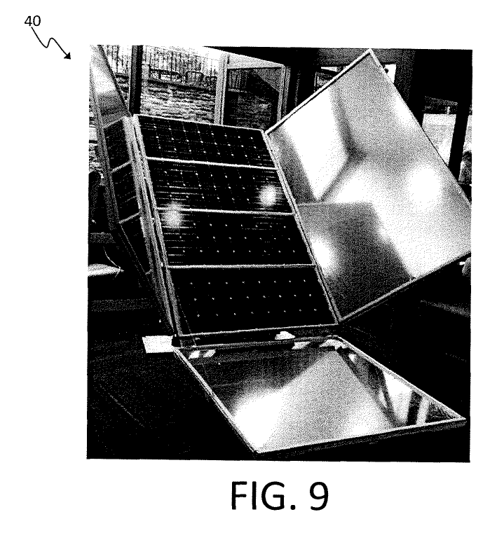

By way of example, one embodiment of controlling a reflective solar tracker (RST) as the tracking device 40 is described below. A separate patent application, entitled Reflective Solar Tracker filed as Provisional App. No. 61/794,343 on Mar. 15, 2013, is incorporated into this document in its entirety for all purposes and showcases the functionality of the control system 30 and its software. An overview picture of the RST is provided in FIG. 9. The primary algorithm 60 uses astronomical data to reposition the RST and collect voltage data for power and energy calculations.

The RST may utilize both reflected sunlight via biaxially oriented polyethylene terephthalate (e.g., MYLAR) panels and a rotating base platform to increase the energy density impinging on commercially available solar panels. The extra sunlight from reflection saturates the individual crystalline solar cells while the rotating base ensures the saturation takes place for a longer portion of the day compared to conventional stationary installations. The repositioning of the base platform may be accomplished using a gear and worm screw turned by a low power DC motor controlled by the RASPBERRY PI® computer.

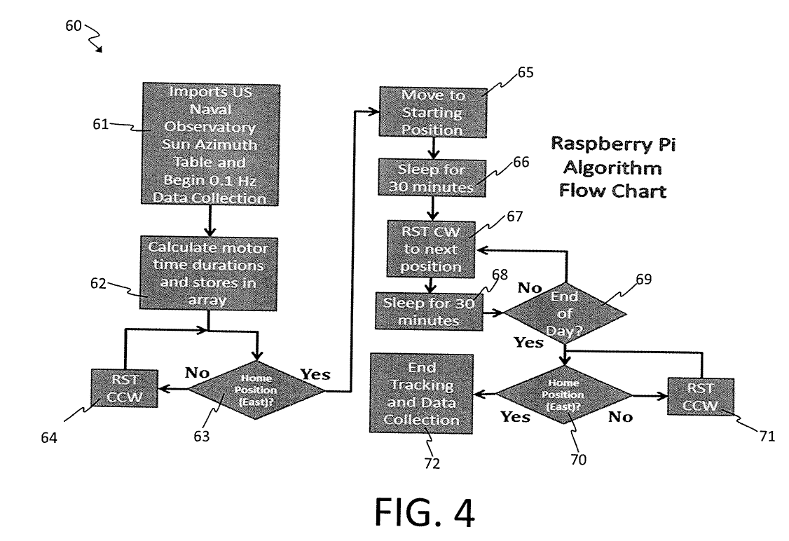

FIG. 4 depicts one example of the primary algorithm 60 for controlling the bi-directional DC motor 34, collecting voltage and current data from a solar panel installation, and using astronomical data to guarantee the RST is always facing the sun. In the tracking and data collecting primary algorithm 60, an importing step 61 includes importing the U.S. Naval Observatory sun azimuth table or tables and beginning 0.1 Hz data collection. After the importing step 61, a calculating step 62 includes calculating motor time durations and storing those durations in an array. The importing step 61 and/or calculating step 62 may occur at any suitable time before and/or during operation of the tracking device 40. In a home position step 63, if the sensor 46 identifies (“no”) that the tracking device 40 is not at the home position (e.g., the Eastern-most position or a rest or sleep position), the RST CCW step 64 causes the RST to move counter-clockwise (CCW) to reset the tracking device 40 to its home position. If the home position step 63 is completed (“yes”), meaning the RST is in the home position, then a starting position step 65 moves the tracking device 40 to the starting position or the first position for optimal performance of the tracking device 40. The movement may provide a constant turning of the tracking device 40 in degrees per second until the desired position is reached. It is possible that the starting position may be the same position as the home position.

After starting position step 65, a sleep step 66 provides for no movement of the tracking device 40 for the specific interval (e.g., 30 minutes). After sleep step 66, a next position step 67 moves the tracking device 40 to its next position, for example, in a clockwise (CW) manner. Again, the movement may provide a constant turning of the tracking device 40 in degrees per second until the desired position is reached. After next position step 67, a sleep step 68 provides for no movement of the tracking device 40 for the specific interval (e.g., 30 minutes). After sleep step 68, an end-of-day step 69 determines if the end of day has been reached (e.g., sunset). If it is not the end of the day (end of day step 69 “no”), the cycle loops back to the next position step 67 to move the tracking device 40 to its next position. This loop continues and repeats until it is the end of the day (end of day step 69 “yes”). Once the end of day step 69 is completed, a home position step 70 identifies if the tracking device 40 is at the home position. If the home position step 70 determines the tracking device 40 is not at the home position, then a RST CCW step 71 causes the RST to move counter-clockwise to reset the tracking device 40 to its home position. This loop continues until the home position is reached. An end step 72 ends the tracking and data collection, for example, for the day.

In summary, the primary algorithm 60, executed by a daily cron job, retrieves the local sun azimuth table containing the sun's position in degrees relative to the Eastern direction for the installation's geographic location in the current month. The hardware allows the motor 34 to turn the base platform in both the clockwise (CW) and counter clockwise (CCW) direction. Beginning at 6:00 am, the algorithm 60 calculates the starting direction in reference to East and moves the base platform CW or CCW to this position. Throughout the rest of the day, the motor 34 is turned on for a specific interval every half hour and moves the base platform CW, in the direction of the sun's trajectory, to the next sun-facing position. The following representative code, which of note utilizes the numpy library, shows the readDayData( ) function that calculates the specific time durations from the imported sun azimuth tables. The durations are stored in the motor_time[ ] array. Once the algorithm 60 reaches the end of the imported file, the RST rotates CCW back to the home position so it is facing East the next day.

month_str = getMonth( )
filepath = ‘/home/pi/RST/Months/’ + month_str + ‘.txt.’
rawData = np.loadtxt(filepath, dtype=(str, float), usecols=(0,2))
motor_const = 0.462 # Units of deg/sec based upon speed of motor
angle_deg = np.zeros ((len(rawData),1), dtype=(float))
motor_dir = np.zeros ((len(rawData),1), dtype=(int))
motor_time = np.zeros ((len(rawData),1), dtype=(int))
def readDayData( ):

z = 0
while (z < len(rawData)):

loop_time[z,0] = int(convTimeSec(rawData[z,0]))
if (z == 0):

if (float (rawData [z,1]) <= 90):

angle_deg[z,0] = 90 − float(rawData(z,1])
motor_dir[z,0] = −1
motor_time[z,0] = angle_deg[z,0] / motor_const

else:

angle_deg[z,0] = float(rawData[z,1]) − 90
motor_dir[z,0] = 1
motor_time[z,0] = angle deg[z,0] / motor_const

else:

angle_deg[z,0] = float(rawData[z,1]) −
float(rawData[z−1,1])
motor_dir[z,0] = 1
motor_time[z,0] = angle_deg[z,0] / motor_const

z = z + 1

For the data logging function, code from the Adafruit ADS1x15 class was used and combined with the python threading class. The method itself is written as a thread that is kicked off in the main method. Once executed, the thread will open a new text file titled with the current date. Inside the file, the thread will log and timestamp data from inputs A1 and A2 from the analog-to-digital converter 42 every 10 seconds (0.1 Hz) until the daily tracking function ends and the thread stops.

class dataLoggingThread(threading.Thread):

def _init_(self, threadID, stop_data_log, delay):

threading.Thread._init_(self)
self.threadID = threadID
self.delay = delay

def run(self):

ADS1015 = 0x00
adc = ADS1x15(ic=ADS1015)
logging.info(timestamp( ) + ‘: Running data logging thread.’)
while not stop_data_log.isSet( ):

file = open(‘/home/pi/RST/Data/’ + today + ‘.txt’, ‘a’)
voltage = adc.readADCSingleEnded(1, 4096, 250) / 1000
file.write(timestamp( ) + ‘\t’ + str(voltage))
current = adc.readADCSSingleEnded(2, 4096, 250) / 1000
file.write(‘\t’ +str(current) + ‘\n’)
file.close( )
time.sleep(self.delay)

logging.info(timestamp( ) + ‘: Exiting data logging thread.’)

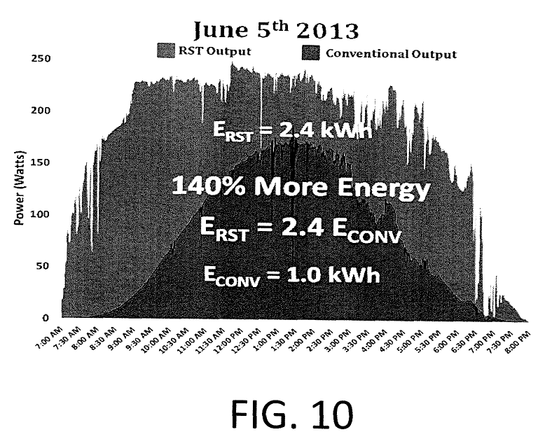

Using the collected voltage and current data from the solar panels, the values may be multiplied together to get the power output of the panels. Integrating these power values in kilowatts over the total amount of hours of sunlight provides the total energy output in kilowatt-hours (kWh) of the installation. As depicted in FIG. 10, the RST energy output is compared to a conventional stationary non-reflective installation. In particular, FIG. 10 shows the plot depicting the power and energy comparison on a perfectly sunny day. Although the RST example is described, it is envisioned that the primary algorithm 60 or a similar algorithm may be used for other solar devices or applications and other devices and applications identified in this document.

Thus, the control systems, methods, and non-transitory computer readable media including software for tracking the celestial object, such as the sun, the moon, or any heavenly body allow the tracking device 40 to perform optimally and efficiently for its intended function. In the case of the solar panel or array, the solar panel is able to produce optimal power outputs. In the case of other devices, such as cameras, antennae, or satellite dishes, the device may track any heavenly object with a known trajectory (e.g., satellites) in order to enhance and improve the device's efficiency and output (e.g., video or radio transmission or reception).

### Examples

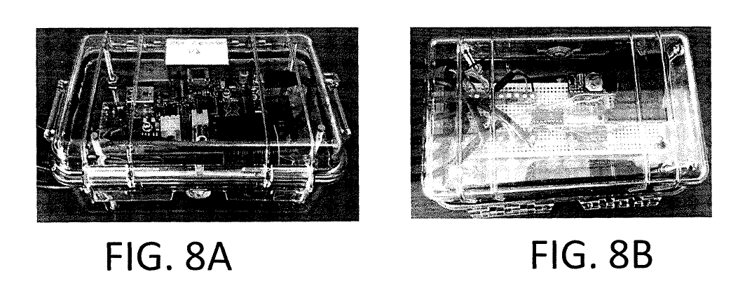

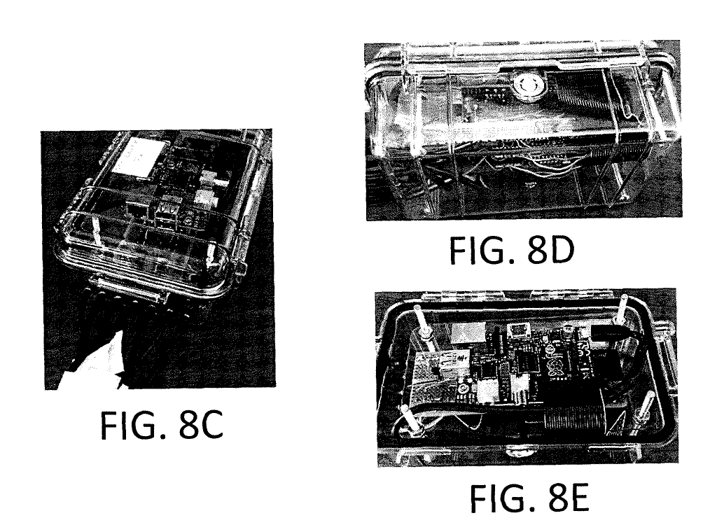

The hardware architecture for the control system, in addition to the RASPBERRY PI® computer, may function with the use of the following products, for example, available from http://www.adafruit.com: the DS1307 real time clock, ADS 1115 16-Bit ADC, L293D H-Bridge motor driver circuit, IR home-position sensor, and a 5200 mAh power bank. The real time clock is used to ensure the program executes daily at the proper time in case of power failure. To minimize the chance of failure, the RASPBERRY PI® computer is powered by a power bank, which is simultaneously being charged by a 5V 1A power adapter. The motor 34 is directly controlled by the H-bridge motor driver circuit 36 that is interfaced with the RASPBERRY PI® computer GPIO pins 38. In addition to the H-bridge motor driver circuit 36 for motor control, an IR home-position sensor is used to ensure the motor 34 is returned to the proper location at the end of every cycle. The hardware architecture also includes an analog-to-digital converter 42 that allows for collection of the solar panel output voltage data throughout the day. Data may also be collected including the voltage across a 1Ω power resistor providing the current. The connections of these components can be viewed in the block diagram provided in FIG. 2. Photographs showing alternative views of the assembled device in a cabinet or case can also be viewed in FIGS. 8A-8E.

The following code prepared in Python is a representative example of software useful in controlling a solar panel application:

import time, subprocess, threading, datetime, logging
import RPi.GPIO as GPIO
import numpy as np
from Adafruit_ADS1x15 import ADS1x15

| | |
|---|---|
| GPIO.setmode(GPIO.BCM) | # Set GPIO pin numbering |
| motorLED = 24 | # Pin assignment for Motor Running |
| | Indicator LED |
| motorCCW = 17 | # Pin assignment for Motor Counter |
| | Clockwise |
| motorCW = 4 | # Pin assignment for Motor Clockwise |
| hbEnable = 21 | # Pin assignment for Enabling H-Bridge |
| homeSensor = 7 | # Pin assignment for Home Sensor |
| PRI_LED = 22 | # Pin assignment for Program Running |
| | Indicator LED |

GPIO.setup(homeSensor, GPIO.IN)
GPIO.setup(motorCW, GPIO.OUT)
GPIO.setup(motorCCW, GPIO.OUT)
GPIO.setup(hbEnable, GPIO.OUT)
GPIO.setup(motorLED, GPIO.OUT)
GPIO.setup(PRI_LED, GPIO.OUT)

| | |
|---|---|
| GPIO.output(PRI_LED, 1) | # Turn on Program Running Indicator |
| | LED |

GPIO.output(motorLED, 0)
GPIO.output(motorCW, 0)
GPIO.output(motorCCW, 0)
GPIO.output(hbEnable, 0)
# Returns YYYY-MM-DD HH:MM:SS time stamp as string
def timestamp( ):

epochtime = int(time.time( ))
timestamp =
datetime.datetime.fromtimestamp(int(epochtime)).strftime(‘%Y-

%m-%d %H:%M:%S’)

return timestamp

# Returns the current YYYY-MM-DD date as string
def getDate( ):

today,now = timestamp( ).split(‘ ’)
return str(today)

# Returns the current HH:MM time as string
def getTime( ):

today,now = timestamp( ).split(‘ ’)
hh,mm,ss = now.split(‘:’)
currentTime = str(hh) + ‘:’ + str(mm)
return currentTime

# Returns the 3 letter month abbreviation of current month
def getMonth( ):

temp = subprocess.Popen([“date”], stdout=subprocess.PIPE)
date_string = temp.communicate( )[0]
t1, month, t2= date_string.split(‘ ’,2)
return month

# Converts time from rawdata array to seconds
def convTimeSec(time_hhmmss):

HH,MM,SS = time_hhmmss.split(‘:’)
time_sec = int(HH)*3600 + int(MM)*60 + int(SS)
return time_sec

#Returns RST to home position
def returnHome( ):

if(GPIO.input(homeSensor) == 1):

logging.info(timestamp( ) + ‘: Returning to home position.’)
GPIO.output(hbEnable, 1)
GPIO.output(motorLED, 1)
GPIO.output(motorCCW, 1)
print “Returning home.”
while (GPIO.input(homeSensor) == 1):

time.sleep(0.1)

print “Found Home”
GPIO.output(motorLED, 0)
GPIO.output(motorCCW, 0)
GPIO.output(hbEnable, 0)

# Populates rawData with current days data from file
def readDayData( ):

z = 0
logging.info(timestamp( ) + ‘: Preparing rawData.’)
print “Preparing rawData.”
while (z < len(rawData)):

loop_time[z,0] = int(convTimeSec(rawData[z,0]))
if (z == 0):

if (float(rawData[z,1]) <= 90):

angle_deg[z,0] = 90 − float(rawData[z,1])
motor_dir[z,0] = −1
motor_time[z,0] = angle_deg[z,0] / motor_const

else:

angle_deg[z,0] = float(rawData[z,1]} − 90
motor_dir[z,0] = 1
motor_time[z,0] = angle_deg[z,0] / motor_const

else:

angle_deg[z,0] = float(rawData[z,1]) −
float(rawData[z−1,1])
motor_dir[z,0] = 1
motor_time[z,0] = angle_deg[z,0] / motor_const

z = z + 1

# Finds start position for the month
def findStart( ):

logging.info(timestamp( ) + ‘: Moving to start position.’)
print “Finding start.”
print “Motor on 1”
if (motor_dir[0,0] == −1):

GPIO.output(motorLED, 1)
GPIO.output(hbEnable, 1)
GPIO.output(motorCCW, 1)
time.sleep(motor_time[0,0])
print “motor off!!”
GPIO.output(motorLED, 0)
GPIO.output(hbEnable, 0)
GPIO.output(motorCCW, 0)

else:

print “motor on 2”
GPIO.output(motorLED, 1)
GPIO.output(hbEnable, 1)
GPIO.output(motorCW, 1)
time.sleep(motor_time[0,0])
print “motor off!!”
GPIO.output(motorLED, 0)
GPIO.output(hbEnable, 0)
GPIO.output(motorCW, 0)

# Primary Tracking loop
def dailyTracking( ):

x = 1
logging.info(timestamp( ) + ‘: Beginning daily tracking’)
print “Beginning daily tracking”
while (x < len(loop_time)):

time.sleep(1800-motor_time[x,0])
logging.debug(timestamp( ) + ‘: Beginning iteration ‘ + str(x))
print “Beginning iteration” + str(x)
GPIO.output(motorLED, 1)
GPIO.output(hbEnable, 1)
GPIO.output(motorCW, 1)
time.sleep(motor_time[x,0])
GPIO.output(motorLED, 0)
GPIO.output(hbEnable, 0)
GPIO.output(motorCW, 0)
logging.debug(timestamp( ) + ‘: Finished with iteration ‘ +
str(x))
print “Finished with iteration” + str(x)
x = x + 1

# Holds execution until time passed in as HH:MM is reached
def waitUntil(waitTime):

target_hour,target_minute = waitTime.split(‘:’)
current_hour,current_minute = getTime( ).split(‘:’)
waiting = True
while waiting:

time.sleep(0.2)
if target_hour == current_hour and target_minute ==

current_minute: waiting = False

if target_hour == current_hour and target_minute <

current_minute or target_hour < current_hour:

logging.warning(timestamp( ) + ‘: Waiting for ‘ + waitTime + ‘,

but that time has past.’)

current_hour,current_minute = getTime( ).split(‘:’)

# Data Logging Thread class
class dataLoggingThread(threading.Thread):

def _{——}init_{——}(self, threadID, stop_data_log, delay):

threading.Thread._{——}init_{——}(self)
self.threadID = threadID
self.delay = delay

def run(self):

ADS1015 = 0x00

# Assigns i2c location

adc = ADS1x15(ic=ADS1115)
logging.info(timestamp( ) + ‘: Running data logging thread.’)
while not stop_data_log.isSet( ):

file = open(‘/home/pi/RST/Data/’ + today + ‘.txt’, ‘a’)

# Opens todays datafile.log for appending

voltage = adc.readADCSingleEnded(1, 4096, 250) / 1000

# Channel 1

file.write(timestamp( ) + ‘\t’ + str(voltage))

# Appends time stamp and voltage to datafile.log

current = adc.readADCSingleEnded(2, 4096, 250) / 1000

# Channel 2

file.write(‘\t’ + str(current) + ‘\n’)

# Appends current to datafile.log

file.close( )
time.sleep(self.delay)

logging.info(timestamp( ) + ‘: Exiting data logging thread.’)

### Variables and useful things
today = getDate( )
# Assigns current YY-MM-DD date to today
debug_log_path = ‘/home/pi/RST/Logging/’ + today + ‘-debug.log’
# File path to debug log
data_log_path = ‘/home/pi/RST/Data/’ + today + ‘.txt’
# File path to data log
file = open(data_log_path, ‘w’)
file.close( )
logging.basicConfig(filename=debug_log_path,level=logging.DEBUG)
# Prepares debug log file
logging.info(timestamp( ) + ‘: Beginning daily routine.’)
data_logging_delay = 10
# Repeat delay for data log data capture events (seconds)
stop_data_log = threading.Event( )
# Initializes flag to stop data logging
log = dataLoggingThread(‘logThread’, stop_data_log,
data_logging_delay)
# Constructs data logging thread
month_str = getMonth( )
# Gives month_str the three letter abbreviation of current month
filepath = ‘/home/pi/RST/Months/’ + month_str + ‘.txt’
# Prepares filepath for rawdata based on month_str
rawData = np.loadtxt(filepath, dtype=(str, float), usecols=(0,2))
motor_const = 0.462
# Establish the motor constant (degrees/seconds)
loop_time = np.zeros((len(rawData),1), dtype=(int))
angle_deg = np.zeros((len(rawData),1), dtype=(float))
motor_dir = np.zeros((len(rawData),1), dtype=(int))
motor_time = np.zeros((len(rawData),1), dtype=(int))
### The Fun Part
def main( ):

| | |
|---|---|
| readDayData( ) | # Reads and prepares the days data from |

| file print “readDayData completed.” | |
|---|---|
| returnHome( ) | # Returns the RST to home position |
| print “returnHome completed.” | |
| findStart( ) | # Finds start position for current month |
| print “findStart completed.” | |
| log.start( ) | # Starts data logging thread |

| print “log.start completed.” | |
|---|---|
| waitUntil(‘06:30’) | # Waits until 06:30am before beginning |

dailyTracking

| print “finished waiting.” | |
|---|---|
| dailyTracking( ) | # Runs todays tracking schedule |

| print “dailyTracking completed.” | |
|---|---|
| stop_data_log.set( ) | # Sets escape flag for data logging |

| print “stop_data_log.set( ) completed.” | |
|---|---|
| returnHome( ) | # Returns the RST to home position |

| print “returnHome completed.” | |
|---|---|
| log.join(data_logging_delay + 2) | # Checks to ensure data |

logging thread has quit, terminates wait after data_logging_delay +
2 seconds

| | |
|---|---|
| if log.isAlive( ): | # If data logging thread is still alive, log as |

warning, we don’t want that thread alive.

logging.warning(timestamp( ) + ‘: Failed to terminate data logging

thread.’)

| logging.info(timestamp( ) + ‘: Ending daily routine.’) | |
|---|---|
| GPIO.cleanup( ) | # Cleaning up.. goodbye. |

main( )

Although illustrated and described above with reference to certain specific embodiments and examples, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges. In addition, features of one embodiment may be incorporated into another embodiment.

What is claimed is:

1. A control system for tracking a celestial object, the control system comprising:
a tracking device;
a motor connected to the tracking device for moving the tracking device; and
a computer in communication with the motor, wherein the computer is adapted to:
(a) obtain astronomical data for a celestial object at a given tabular interval based on a location of the tracking device and a date,
(b) calculate an amount of movement for the tracking device based on the astronomical data including a motor time duration for each tabular interval,
(c) activate the motor to reposition the tracking device by moving the tracking device for the amount of movement calculated to track the celestial object based on the astronomical data for the celestial object, and
(d) repeatedly reposition the tracking device throughout the tabular interval to track the celestial object.

2. The system of claim 1 further comprising an analog-to-digital converter to collect data from the tracking device.

3. The system of claim 2, wherein the tracking device includes at least one solar panel, and the data include solar panel output voltage and current data writable to a data file.

4. The system of claim 1 further comprising a wireless connection configured to allow a user to interface with the computer, upload the astronomical data for the celestial object, retrieve data obtained from the tracking device, or a combination of these functions.

5. The system of claim 1, wherein the amount of movement is a constant movement of the motor provided for the motor time duration at each tabular interval.

6. The system of claim 1, further comprising a home position sensor including an emitting diode detector to determine if the tracking device is positioned in an initial start position.

7. The system of claim 1, further comprising a real time clock to determine a present month, day, and year.

8. The system of claim 1, further comprising a power supply including a power bank and a power adapter.

9. The system of claim 1, wherein the motor is a bi-directional DC motor.

10. The system of claim 1, wherein the celestial object is the sun, the moon, or any heavenly body.

11. The system of claim 1, wherein the tracking device includes one or more of a solar panel, a telescope, an antenna, a satellite dish, and a camera.

12. The system of claim 1, further comprising an H-bridge motor driver circuit connecting the computer to the motor, the H-bridge motor driver circuit adapted to apply a load to the motor.

13. A method for tracking a celestial object using a system comprising a tracking device; a motor connected to the tracking device for moving the tracking device; and a computer in communication with the motor, the method comprising:
(a) importing astronomical data for the celestial object to the computer, the astronomical data having a given tabular interval based on a location and a date;
(b) the computer calculating an amount of movement for the tracking device based on the astronomical data, the calculated amount of movement including a motor time duration for each tabular interval;
(c) the motor repositioning the tracking device by moving the tracking device the amount of movement calculated in step (b) to track the celestial object based on the astronomical data for the celestial object; and
(d) repeating step (c) for each tabular interval such that the tracking device follows the celestial object for a given duration.

14. The method of claim 13, further comprising starting the tracking device at a home position before repositioning the tracking device.

15. The method of claim 14, further comprising determining the home position using a home position sensor.

16. The method of claim 13, further comprising collecting and storing the astronomical data in a text file.

17. The method of claim 13, wherein the location is based on a location of the tracking device defined in longitude and latitude.

18. The method of claim 13, wherein the astronomical data are imported automatically by the computer.

19. The method of claim 13, wherein importing astronomical data includes a user wirelessly uploading the astronomical data to the computer.

20. The method of claim 13, wherein the tracking device comprises at least one solar panel, the method further comprising collecting voltage data, current data, or both types of data from the tracking device for power and energy calculations.
